(19) United States
(12) Patent Application Publication
(10) Pub. No.: US 2026/0367568 A1
(43) Pub. Date: Nov. 19, 2026

(54) IMAGE FORMING APPARATUS

(71) Applicant: KYOCERA Document Solutions Inc., Osaka (JP)

(72) Inventor: Tatsuro ARATA, Osaka (JP)

(73) Assignee: KYOCERA Document Solutions Inc., Osaka (JP)

(21) Appl. No.: 19/670,743

(22) Filed: May 7, 2026

(30) Foreign Application Priority Data
May 16, 2025 (JP) 2025-082706

(51) Int. Cl. G03G 21/16; G03G 15/01; G03G 15/08

(52) U.S. Cl. CPC G03G 21/1647; G03G 15/0865; G03G 15/0121; G03G 15/0189; G03G 2221/1654

(57) ABSTRACT

An image forming apparatus includes an image carrier, a developing device, a separation device, and a pressing device. The developing device includes a developing member rotating around an axis, is attached to the apparatus main body movably in an axial direction, and brings the developing member close to or in contact with the image carrier to develop an electrostatic latent image. The separation device turns the developing device between a developing position where the developing device can perform the developing the electrostatic latent image and a separation position where the developing device can move in the axial direction. The pressing device presses the developing device from the separation position to the developing position. The developing device is turned from the developing position to the separation position against a pressing force of the pressing device and moves in the axial direction while applied with the pressing force from the pressing device.

### INCORPORATION BY REFERENCE

This application is based on and claims the benefit of priority from Japanese patent application No. 2025-082706 filed on May 16, 2025 which is incorporated by reference in its entirety.

### BACKGROUND

The present disclosure relates to an image forming apparatus.

For example, an electrophotographic image forming apparatus includes a developer carrier (developing device) for developing an electrostatic latent image carried on an image carrier (image carrier unit), a unit support frame for supporting the image carrier unit and the developing device, and a developing device moving mechanism for moving the developing device. The image forming apparatus is provided with a retainer which is turned in a first direction for attaching the developing device to the unit support frame to position the image carrier, and is turned in a second direction for pulling out the developing device from the unit support frame to release the positioning of the image carrier. The developing device moving mechanism disposes the developing device to a developing position where the developing device is brought into contact with or close to the image carrier in conjunction with the turning of the retainer in the first direction, and disposes the developing device to a separation position where the developing device is separated from the image carrier in conjunction with the turning of the retainer in the second direction.

### SUMMARY

An image forming apparatus according to the present disclosure includes an image carrier, a developing device, a separation device, and a pressing device. The image carrier is attached to an apparatus main body, and carries an electrostatic latent image while rotating around an axis. The developing device includes a developing member rotating around an axis, is attached to the apparatus main body movably in an axial direction, and brings the developing member close to or in contact with the image carrier to develop the electrostatic latent image. The separation device turns the developing device between a developing position where the developing device can perform the developing the electrostatic latent image and a separation position where the developing device can move in the axial direction. The pressing device presses the developing device from the separation position to the developing position. The developing device is turned from the developing position to the separation position against a pressing force of the pressing device and moves in the axial direction while applied with the pressing force from the pressing device.

The above and other objects, features, and advantages of the present disclosure will become more apparent from the following description when taken in conjunction with the accompanying drawings in which a preferred embodiment of the present disclosure is shown by way of illustrative example.

### BRIEF DESCRIPTION OF THE DRAWINGS

FIG. 1 is a perspective view showing an image forming apparatus according to one embodiment of the present disclosure.

FIG. 2 is a schematic (side) view showing the inner structure of the image forming apparatus according to the embodiment of the present disclosure.

FIG. 3 is a perspective view showing a photoconductive drum, a developing device, and a separation device of the image forming apparatus according to the embodiment of the present disclosure.

FIG. 4 is a plan view showing the separation device (initial state, normal printing state) of the image forming apparatus according to the embodiment of the present disclosure.

FIG. 5 is a cross-sectional view taken along the line V-V of FIG. 4.

FIG. 6 is a right side view showing the photoconductive drum, the developing device (developing position), and the separation device of the image forming apparatus according to the embodiment of the present disclosure.

FIG. 7 is a disassembled perspective view showing a rotation transmission device and the separation device of the image forming apparatus according to the embodiment of the present disclosure.

FIG. 8 is an explanatory view (left side view, cross-sectional view taken along the line A-A) explaining a state in which a drive force can be transmitted to a developing roller, in the rotation transmission device of the image forming apparatus according to the embodiment of the present disclosure.

FIG. 9 is an explanatory view (left side view, cross-sectional view taken along the line B-B) explaining a state in which the drive force cannot be transmitted to the developing roller, in the rotation transmission device of the image forming apparatus according to the embodiment of the present disclosure.

FIG. 10 is a disassembled perspective view showing the separation device of the image forming apparatus according to the embodiment of the present disclosure.

FIG. 11 is a perspective view showing a part of the developing device and a pressing device of the image forming apparatus according to the embodiment of the present disclosure.

FIG. 12 is a plan view showing the developing device (developing position) and the pressing device of the image forming apparatus according to the embodiment of the present disclosure.

FIG. 13 is a cross-sectional view taken along the line XIII-XIII of FIG. 12.

FIG. 14 is a plan view showing the separation device (insertable/removable state) of the image forming apparatus according to the embodiment of the present disclosure.

FIG. 15 is a cross-sectional view taken along the line XV-XV of FIG. 14.

FIG. 16 is a right side view showing the photoconductive drum, the developing device (separation position), and the separation device of the image forming apparatus according to the embodiment of the present disclosure.

FIG. 17 is a plan view showing the developing device (separation position) and the pressing device of the image forming apparatus according to the embodiment of the present disclosure.

FIG. 18 is a cross-sectional view taken along the line XVIII-XVIII of FIG. 17.

FIG. 19 is a plan view showing a process of pulling out the developing device of the image forming apparatus according to the embodiment of the present disclosure.

FIG. 20 is a cross-sectional view taken along the line XX-XX of FIG. 19.

FIG. 21 is a plan view showing the separation device (monochrome printing state) of the image forming apparatus according to the embodiment of the present disclosure.

FIG. 22 is a cross-sectional view taken along the line XXII-XXII of FIG. 21.

### DETAILED DESCRIPTION

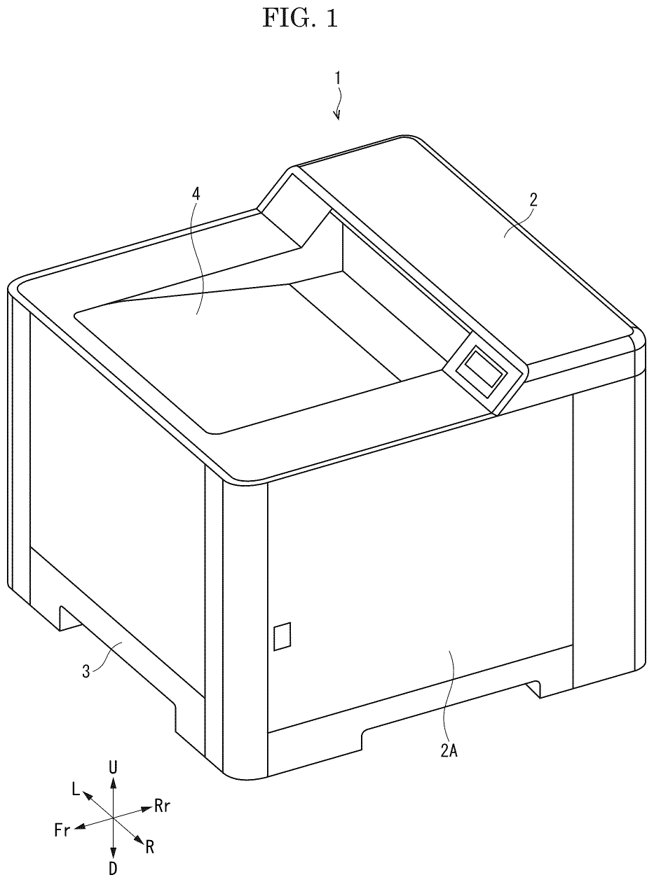

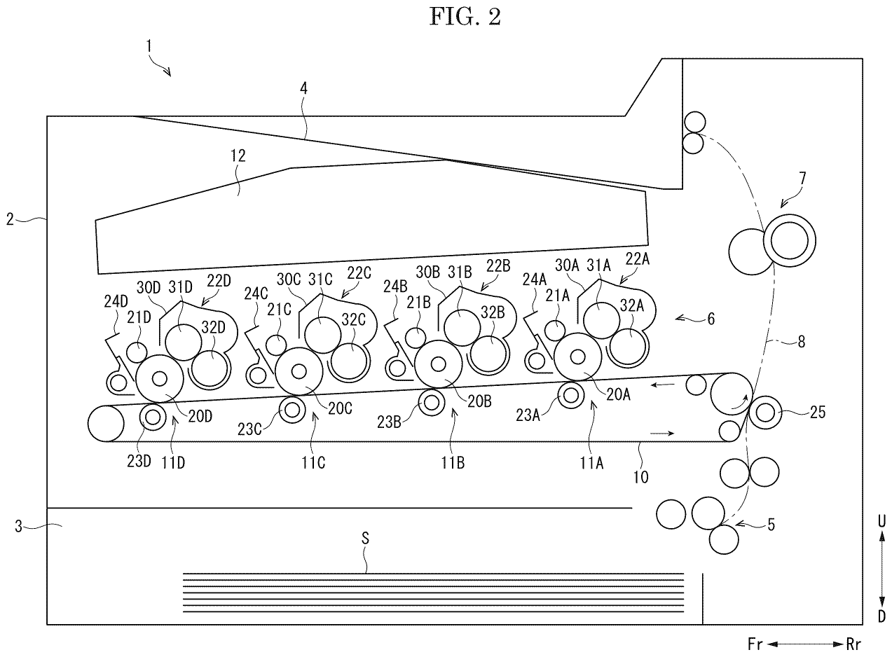

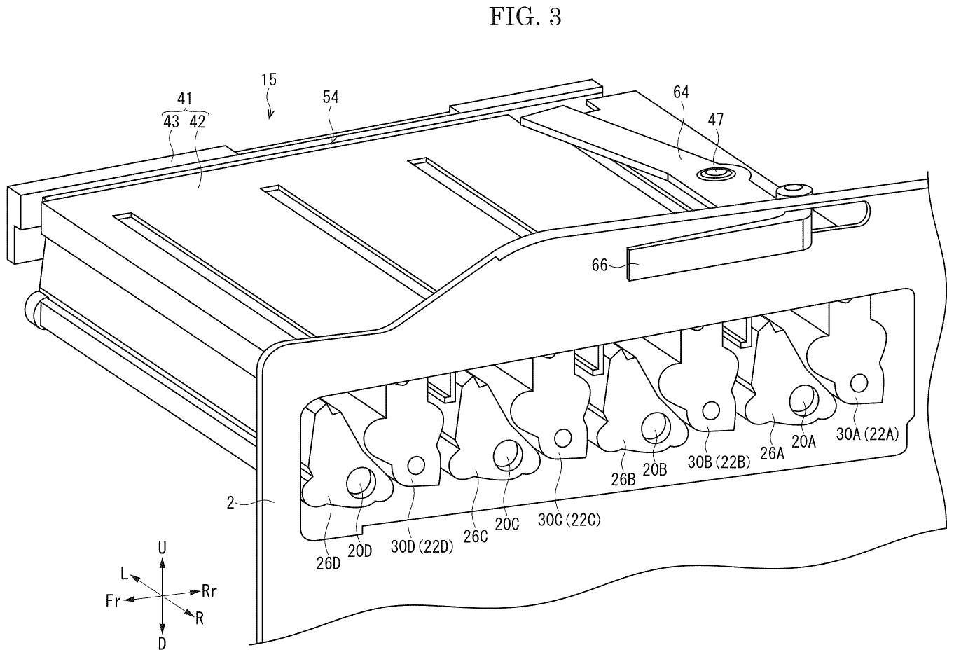

Hereinafter, with reference to the attached drawings, embodiments of the present disclosure will be described. Fr, Rr, L, R, U, and D in the drawings indicate the front, rear, left, right, upper, and down. The front-and-rear direction (separation direction), the left-and-right direction (axial direction), and the upper-and-lower direction are orthogonal to each other. Although the directional and positional terms are used in the specification, these terms are used for convenience of description and are not intended to limit the scope of the disclosure. In the drawings, the shapes, dimensions, angles, and the like of the respective constituent members are not accurate but are schematized for the purpose of explanation.

[Image Forming Apparatus] With reference to FIG. 1 to FIG. 3, the image forming apparatus 1 according to this embodiment will be described. FIG. 1 is a perspective view showing the image forming apparatus 1. FIG. 2 is a schematic view (side view) showing the image forming apparatus 1. FIG. 3 is a perspective view showing a photoconductive drum 20, a developing device 22, and a separation device 15.

The image forming apparatus 1 is a printer which forms an image on a sheet S (medium) by an electrophotographic method. As shown in FIG. 1 and FIG. 2, the image forming apparatus 1 includes an apparatus main body 2 having a substantially rectangular parallelepiped appearance. In the lower portion in the apparatus main body 2, a sheet feeding cassette 3 which stores the sheet S is detachably attached. A discharge tray 4 which receives the image-formed sheet S is provided on the upper surface of the apparatus main body 2. The apparatus main body 2 includes a frame constituting the skeleton of the image forming apparatus 1, and an exterior member attached to the frame and constituting the exterior of the image forming apparatus 1. The sheet S is not limited to a paper sheet but may be made of resin or the like. Further, the terms “upstream”, “downstream”, and similar terms in the specification refer to the “upstream”, “downstream”, and similar concepts in the conveying direction of the sheet S.

As shown in FIG. 2, a conveying path 8 along which the sheet S is conveyed from the sheet feeding cassette 3 to the discharge tray 4 is provided inside the apparatus main body 2. A sheet feeding device 5 is provided at the upstream end of the conveying path 8, an image forming device 6 is provided at the midstream portion of the conveying path 8, and a fixing device 7 is provided at the downstream side portion of the conveying path 8.

The image forming device 6 includes an intermediate transfer belt 10, four image forming parts 11A to 11D, and an exposure device 12. The intermediate transfer belt 10 is wound around a plurality of rollers provided above the sheet feeding cassette 3. The intermediate transfer belt 10 travels in the counterclockwise direction in FIG. 2 by rotating one roller connected to a belt motor (not shown). The four image forming parts 11A to 11D are arranged side by side in the front-and-rear direction (separation direction) above the intermediate transfer belt 10. As an example, the four image forming parts 11A to 11D form yellow, magenta, cyan, and black images in order from the rear to the front in FIG. 2. The exposure device 12 is provided above the four image forming parts 11A to 11D.

Since the four image forming parts 11A to 11D have substantially the same structure, in description common to the four image forming parts 11A to 11D in the specification, attention is sometimes paid to any one image forming part 11 and only arithmetic numerals are attached to the reference numerals. Also, “A, B, C, and D” may be added to the reference numerals of the constituent elements included in the image forming parts 11A to 11D and the reference numerals of the constituent elements provided corresponding to the image forming parts 11A to 11D. Also, in the specification, attention is mainly paid to one of these constituent elements, and only arithmetic numeral is sometimes attached to the reference numeral.

The image forming parts 11A to 11D include photoconductive drums 20A to 20D, charging devices 21A to 21D, developing devices 22A to 22D, primary transfer rollers 23A to 23D, and cleaning devices 24A to 24D. The photoconductive drums 20A to 20D, the charging devices 21A to 21D, the developing devices 22A to 22D, the primary transfer rollers 23A to 23D, and the cleaning devices 24A to 24D are provided corresponding to one monochrome image corresponding to toner of black color and three color images corresponding to toner of colors other than black.

The photoconductive drum 20 as an example of the image carrier is formed in a substantially cylindrical shape extending in the left-and-right direction, and is housed and unitized in a photoconductive drum container 26 (26A to 26D) (see FIG. 3). The photoconductive drum 20 is supported by the photoconductive drum container 26 rotatably around an axis. The photoconductive drum 20 is rotationally driven by a drive motor (not shown) connected via a power transmission mechanism (not shown) such as a gear train while in contact with the intermediate transfer belt 10. The charging device 21, the developing device 22, the primary transfer roller 23, and the cleaning device 24 are arranged around the photoconductive drum 20 in the order of the image forming process. The primary transfer roller 23 faces the photoconductive drum 20 across the intermediate transfer belt 10. A secondary transfer roller 25 is in contact with the rear side portion of the intermediate transfer belt 10.

The developing device 22 is disposed on the rear side of the photoconductive drum 20, for example. The developing devices 22A to 22D include developing containers 30A to 30D, developing rollers 31A to 31D, and supply rollers 32A to 32D.

The developing container 30 is made of, for example, synthetic resin material, and formed in a box shape capable of containing the toner (developer). A toner container (not shown) is connected to the developing container 30 via a replenishment path (not shown), and the toner (developer) supplied from the toner container is stored in the developing container 30. As an example, the four developing containers 30A to 30D are filled with the toner of yellow, magenta, cyan, and black colors in order from the rear to the front in FIG. 2. The developing roller 31 and the supply roller 32 are formed into substantially cylindrical shapes extending in the left-and-right direction, and are arranged in the developing container 30. The developing roller 31 and the supply roller 32 are supported by the developing container 30 rotatably around axes.

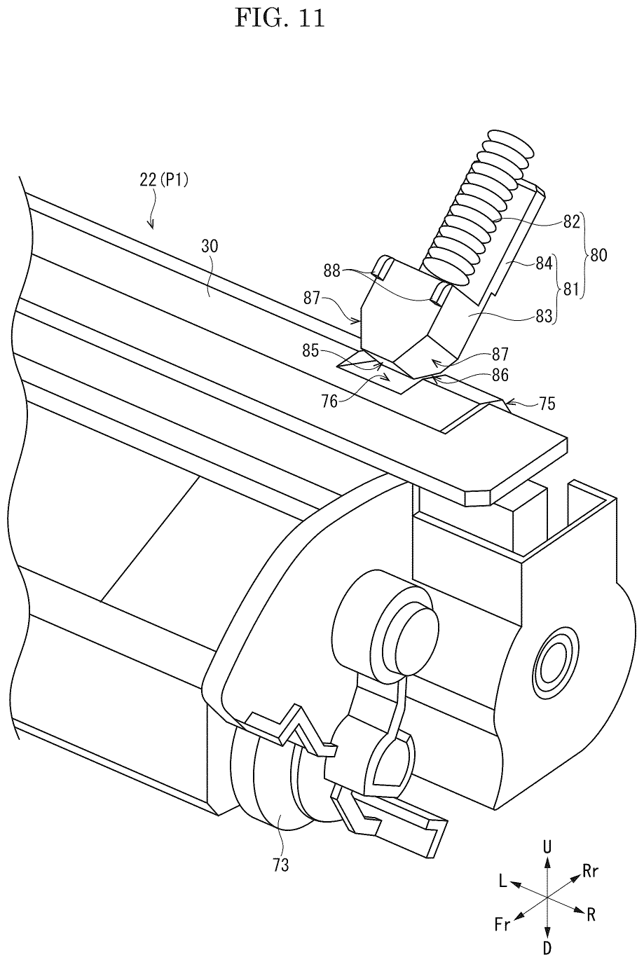

The developing roller 31, which is an example of the developing member, is close to the photoconductive drum 20 from the rear side (more specifically, the rear oblique upper side (one side in the separation direction)). At both axial end portions of the developing roller 31, a pair of regulating rollers 73 (73A to 73D) are provided on the same axis as the developing roller 31 (see FIG. 11 described later). Each of the pair of regulating rollers 73 is formed to have a diameter slightly larger than that of the developing roller 31, and is in contact with both axial end portions of the outer peripheral surface of the photoconductive drum. The developing roller 31 faces the outer peripheral surface of the photoconductive drum 20 with a slight gap corresponding to the difference in the outer diameter between the regulating roller 73 and the developing roller 31. The supply roller 32 is arranged below the developing roller 31 and supplies the toner in the developing container 30 to the outer peripheral surface of the developing roller 31.

As will be described later in detail, the developing roller 31 and the supply roller 32 are connected to a driving motor via a drive input gear 36, a drive coupling 38, and the others. The developing roller 31 is applied with a drive force from the driving motor and rotates around the axis while being close to the photoconductive drum 20. The supply roller 32 rotates around an axis interlocked with the developing roller 31. Although the developing roller 31 rotates around the axis while being close to the photoconductive drum 20, not limited to this, the developing roller 31 may rotate around the axis while being in contact with the photoconductive drum 20 (not shown).

[Image Forming Process] The image forming apparatus 1 forms an image on the sheet S based on image data transmitted from, for example, an external terminal (such as a personal computer). A control part (not shown) provided in the image forming apparatus 1 controls the image forming apparatus 1 based on the input image data, and the image forming process is executed as follows.

The charging device 21 charges the surface of the photoconductive drum 20. The exposure device 12 performs exposure corresponding to the image data toward the photoconductive drum 20 and forms an electrostatic latent image on the surface of the photoconductive drum 20. The photoconductive drum 20 carries the electrostatic latent image while rotating around the axis. The developing roller 31 supplies the toner to the photoconductive drum 20 while rotating around the axis. The developing device 22 develops the electrostatic latent image on the photoconductive drum 20 by bringing the developing roller 31 rotating around the axis close to the photoconductive drum 20. The toner images of the four colors carried on the four photoconductive drums 20A to 20D are sequentially primarily transferred to the intermediate transfer belt 10 by the primary transfer rollers 23A to 23D to which primary transfer biases are applied. Thus, a full-color toner image is formed on the surface of the intermediate transfer belt 10.

The sheet S is fed from the sheet feeding cassette 3 to the conveying path 8 by the sheet feeding device 5, and the toner image carried on the intermediate transfer belt 10 is secondarily transferred to the sheet S by the secondary transfer roller 25 to which a secondary transfer bias is applied. The toner image is thermally fixed to the sheet S by the fixing device 7, and then the sheet S is discharged to the discharge tray 4. The toner remaining on the surface of the photoconductive drum 20 is removed by the cleaning device 24, and the charge on the photoconductive drum 20 is removed by a static eliminator (not shown).

In the image forming apparatus 1, for example, the photoconductive drum 20 and the developing device 22 are attached to the apparatus main body 2 so as to be movable in the left-and-right direction (axial direction) for maintenance and replacement of the photoconductive drum 20 and the developing device 22. As an example, a cover 2A (see FIG. 1) is openably and closably provided on the right side surface of the apparatus main body 2. The cover 2A is turnably provided, for example, around upper and lower hinges (not shown) spaced apart in the upper-and-lower direction at the rear portion. By opening the cover 2A, the right side portion of the image forming device 6 including the developing device 22 and the others is exposed (see FIG. 3), and the attaching/detaching operation of the developing device 22 and the others becomes possible. Since the photoconductive drum 20 is housed and unitized in the photoconductive drum container 26, the unitized photoconductive drum 20 is attached to and detached from the apparatus main body 2.

When the photoconductive drum 20 or the developing device 22 is attached or detached in the state where the developing roller 31 is brought close to the photoconductive drum 20, the developing roller 31 and the photoconductive drum 20 may come into contact with each other and be damaged. Therefore, when the photoconductive drum 20 or the others is attached or detached, it is necessary to separate the developing roller 31 from the photoconductive drum 20. Further, before the developing roller 31 (developing device 22) is separated from the photoconductive drum 20, it is necessary to decouple the developing roller 31 from the driving motor.

When a monochrome image is formed, the color image developing roller 31 is preferably separated from the photoconductive drum 20 in order to suppress deterioration of the color image developing rollers 31 and the photoconductive drums 20. Further, when the monochrome image is formed, it is preferable to decouple the color image developing rollers 31 from the driving motors in order to suppress deterioration of the toner in the developing containers 30 of the color image developing devices 22 due to continuous agitation.

Therefore, the image forming apparatus 1 according to the present embodiment is provided with a separation device 15 which separates the developing roller 31 from the photoconductive drum 20 and decouples the developing roller 31 from the driving motor when the developing device 22 is attached to and detached from the apparatus main body 2.

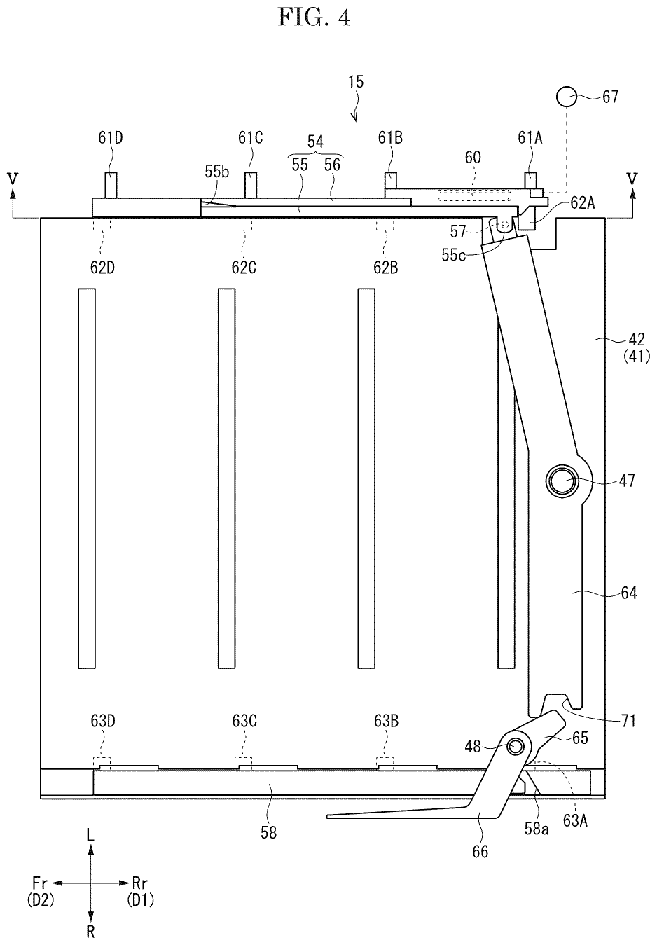

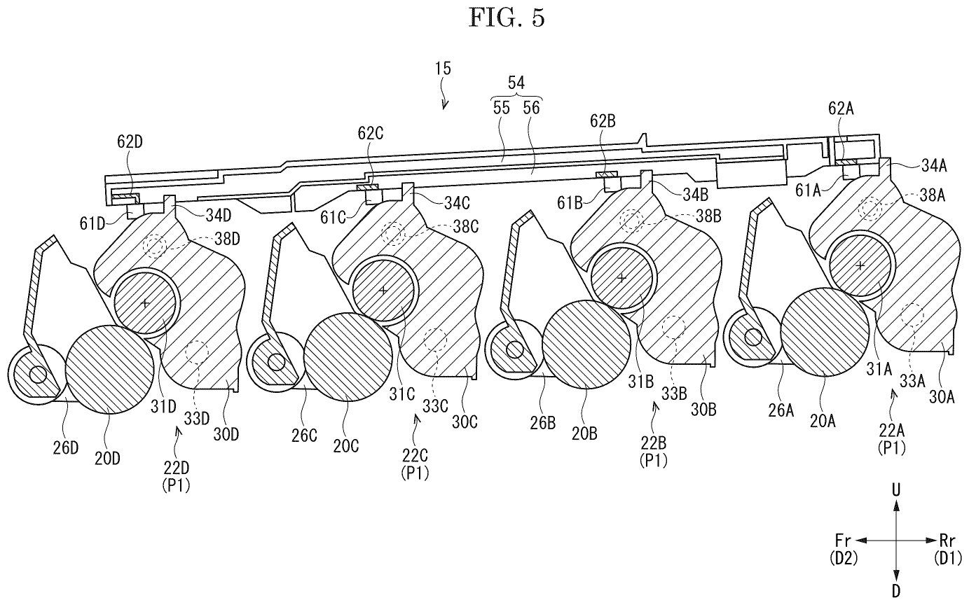

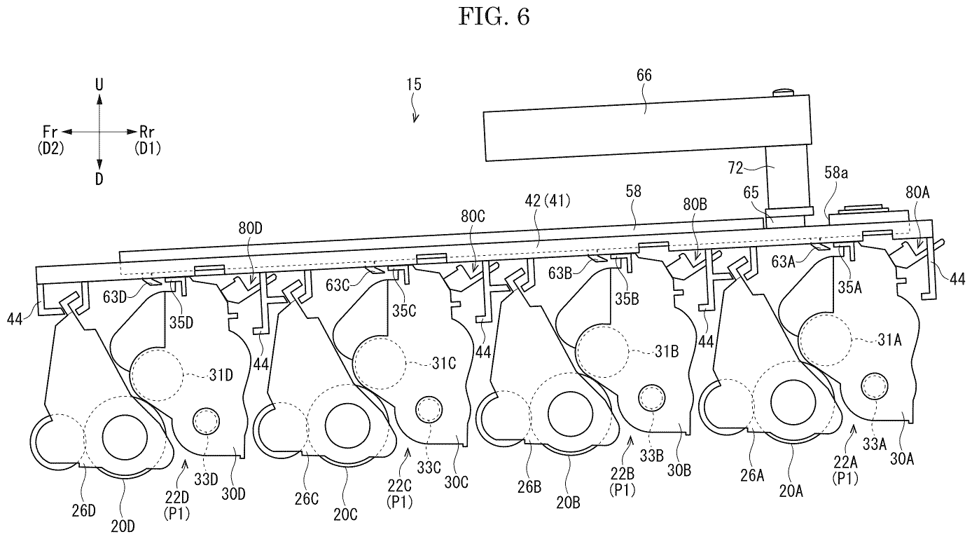

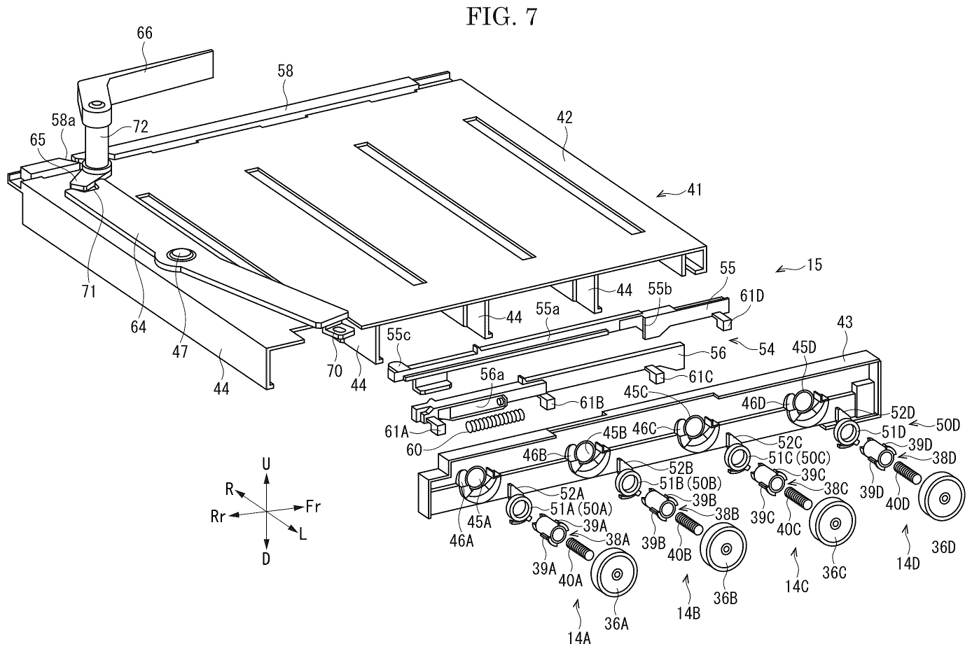

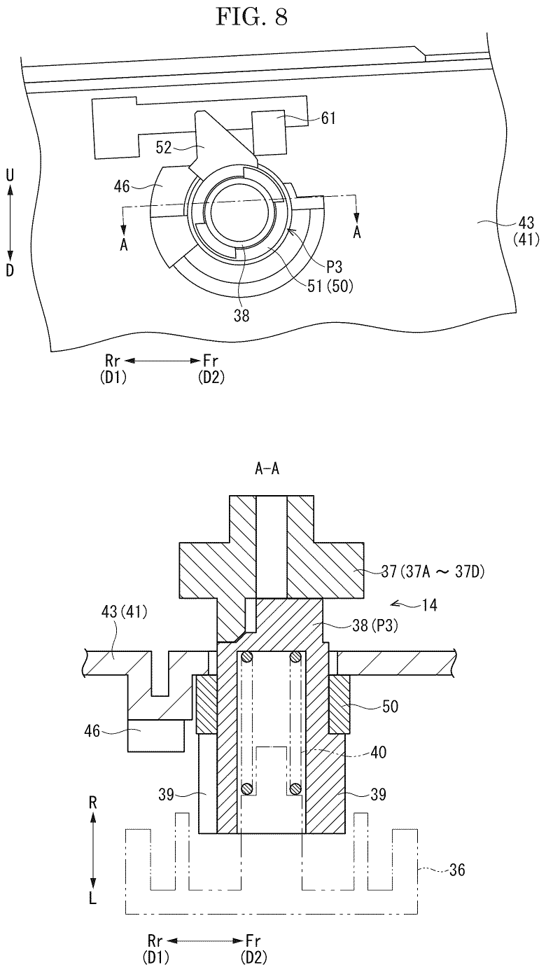

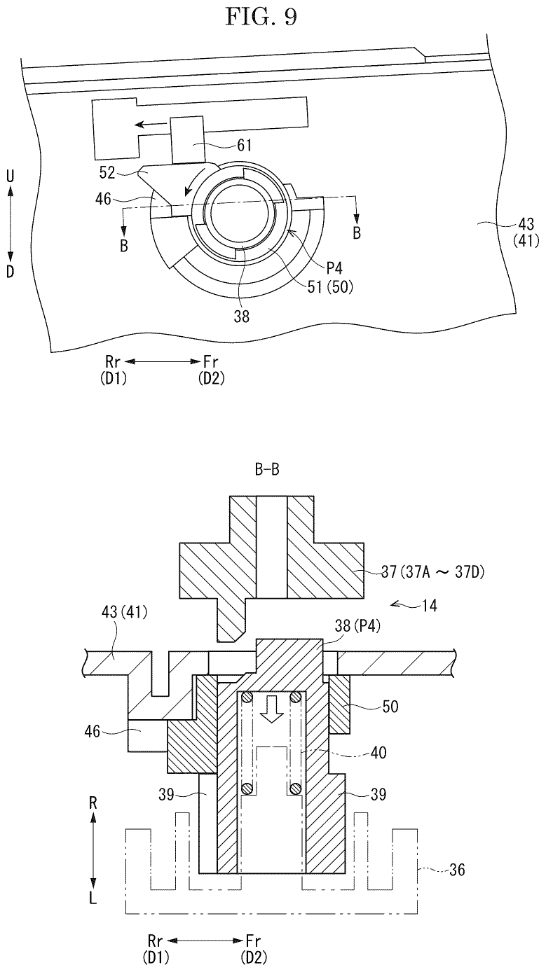

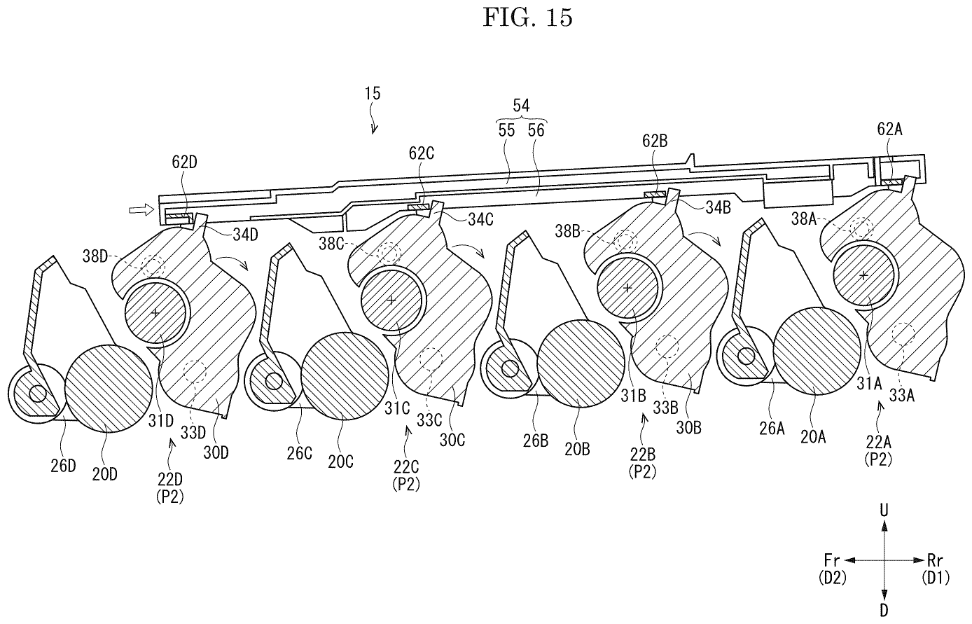

Prior to the description of the separation device 15, with reference to FIG. 4 to FIG. 9, rotation transmission devices 14A to 14D for transmitting the drive force (rotational force) to the developing devices 22A to 22D and the developing rollers 31A to 31D will be described. FIG. 4 is a plan view showing the separation device 15. FIG. 5 is a cross-sectional view taken along the line V-V of FIG. 4. FIG. 6 is a right side view showing the photoconductive drum 20, the developing device 22, and the separation device 15. FIG. 7 is a disassembled perspective view showing the rotation transmission device 14 and the separation device 15. FIG. 8 and FIG. 9 are explanatory views (left side view, cross-sectional view) explaining the operation of the rotation transmission device 14.

[Developing Device] The developing device 22 is supported by the apparatus main body 2 so as to be swingable in the front-and-rear direction. More specifically, as shown in FIG. 5, the developing device 22 swings around swing shafts 33 (33A to 33D) arranged in parallel with the developing roller 31 and disposed radially offset from the developing roller 31. The swing shafts 33 are provided on both left and right side surfaces of the developing container 30. The swing shaft 33 is provided at a position below (in detail, rearward and obliquely downward) the rotational center (see the cross mark in FIG. 5) of the developing roller 31 as viewed from the side of the developing container 30. The developing device 22 turns between a developing position P1 (see FIG. 5 and FIG. 6) for bringing the developing roller 31 close to the photoconductive drum 20 and a separation position P2 (see FIG. 15, described later) for separating the developing roller 31 rearward from the photoconductive drum 20. At the developing position P1, the developing of the electrostatic latent image by the developing device 22 becomes possible. At the separation position P2, the moving of the developing device 22 along the axial direction becomes possible. In the state where the developing device 22 is disposed at the separation position P2, the photoconductive drum 20 and the developing device 22 can be pulled out from the apparatus main body 2 rightward (one side in the axial direction).

As shown in FIG. 5, first engagement portions 34A to 34D are provided at the upper portions of the left end portions of the developing containers 30A to 30D. The first engagement portion 34 is formed into a projection projecting upward from the upper portion of the left end portion of the developing container 30. As shown in FIG. 6, second engagement portions 35A to 35D are provided at the upper portions of the developing containers 30A to 30D over substantially the entire left-and-right direction. The second engagement portion 35 is formed in a substantially L-shaped rail shape projecting upward from the upper portion of the developing container 30 and bending forward when viewed from the side.

[Rotation Transmission Device] As shown in FIG. 7, the rotation transmission devices 14A to 14D are provided on the left side (the other side in the axial direction) of the developing devices 22A to 22D. The rotation transmission devices 14A to 14D include drive input gears 36A to 36D, drive transmission gears 37A to 37D (see FIG. 8 and FIG. 9), and drive couplings 38A to 38D. The drive input gears 36A to 36D, the drive transmission gears 37A to 37D, and the drive couplings 38A to 38D are provided corresponding to one monochrome image and three color images. The drive input gear 36, the drive transmission gear 37 and the drive coupling 38 are arranged in a row in the left-and-right direction (axial direction).

<Drive Input Gear, Drive Transmission gear> The drive input gear 36 (drive input member) is, for example, a spur gear, and is supported by the later-described separation device 15 rotatably around an axis. The drive input gear 36 is connected to the driving motor via a gear train (not shown) or the like. The drive transmission gear 37 is, for example, a spur gear, and is supported by the developing container 30 rotatably around an axis. The drive transmission gear 37 is connected to the developing roller 31 and the supply roller 32 via an intermediate gear (not shown) and the others.

<Drive Coupling> As shown in FIG. 7 and FIG. 8, the drive coupling 38 is formed in a substantially cylindrical shape with the right end surface closed. A pair of drive ribs 39 (39A to 39D) project radially outward from the outer peripheral surface of the drive coupling 38. The pair of drive ribs 39 are provided at positions linearly symmetrical across the axial center of the drive coupling 38. The drive coupling 38 is provided so as to be movable in the left-and-right direction (axial direction) between the drive input gear 36 and the drive transmission gear 37. The drive coupling 38 moves between a coupling position P3 (see FIG. 8) for coupling the drive input gear 36 and the drive transmission gear 37 and a separation position P4 (see FIG. 9) in which the drive coupling 38 is close to the drive input gear 36 and separates from the drive transmission gear 37.

A biasing coupling member 40 (40A to 40D) (for example, a compression coil spring) is housed in the axial center portion of the drive coupling 38. The biasing coupling member 40 is provided between the drive input gear 36 and the drive coupling 38, and biases the drive coupling 38 toward the drive transmission gear 37. That is, the drive coupling 38 is pushed toward the coupling position P3 by the biasing coupling member 40 (see FIG. 8).

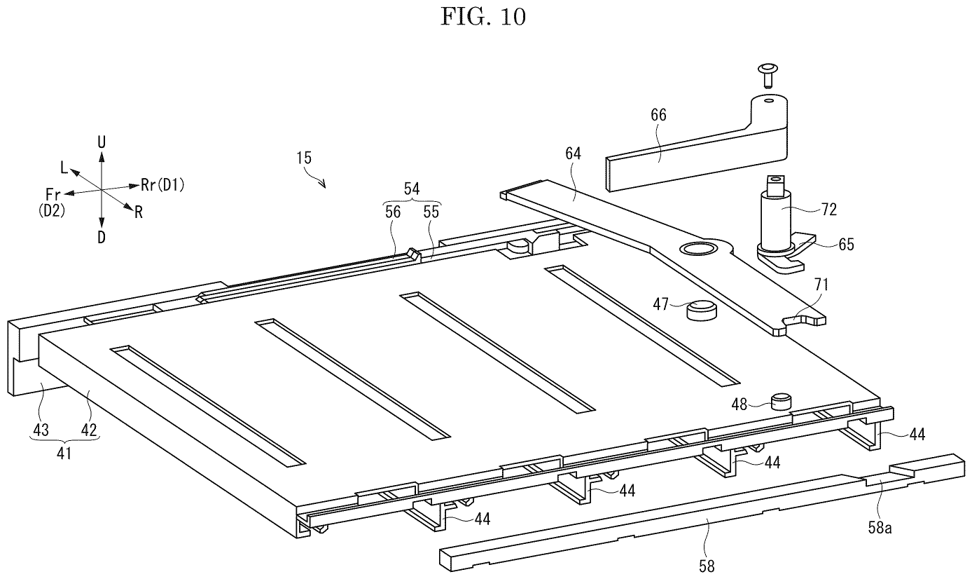

The developing roller 31 is disposed offset rightward (one side in the axial direction) from the drive input gear 36. When the drive coupling 38 is disposed at the coupling position P3, the developing roller 31 is coupled to the right surface (one axial end portion) of the drive input gear 36 via the drive transmission gear 37 and the drive coupling 38. Thus, the drive input gear 36 is brought into a state capable of inputting the drive force to the developing roller 31 and the supply roller 32 via the drive transmission gear 37 and the drive coupling 38.

[Separation Device] Next, with reference to FIG. 4 to FIG. 10, the separation device 15 will be described. FIG. 10 is a disassembled perspective view showing the separation device 15.

The separation device 15 has a function of turning the developing device 22 between the developing position P1 and the separation position P2 and a function of switching the coupling state between the developing roller 31 and the drive input gear 36. As shown in FIG. 7, the separation device 15 includes a support member 41, release arms 50A to 50D, a first slider 54, a second slider 58, a first link 64, a second link 65, a manual lever 66, and a slide driving part 67 (see FIG. 4).

<Support Member> As shown in FIG. 7, the support member 41 has a support body part 42 and an attachment guide 43. The support body part 42 is formed in a flat plate shape to cover the upper portions of the four developing devices 22A to 22D (see FIG. 6). On the lower surface of the support body part 42, rail portions 44 are provided projecting downward to support the unitized photoconductive drums 20 and the developing devices 22 slidably in the left-and-right direction (axial direction) (see FIG. 6).

The attachment guide 43 is attached to the left end portion (the other end portion in the axial direction) of the support body part 42 with a gap in which the first slider 54 described later can be disposed (see FIG. 10). The attachment guide 43 has shaft holes 45A to 45D at equal intervals in the front-and-rear direction (the separation direction). The shaft hole 45 is a circular opening, and the drive coupling 38 is inserted into the shaft hole 45. The attachment guide 43 (support member 41) supports the drive coupling 38 so as to be rotatable and movable in the left-and-right direction (axial direction). On the left side surface of the attachment guide 43, inclined surface portions 46A to 46D are formed along the rear edges of the shaft holes 45A to 45D. The inclined surface portion 46 has a surface inclined leftward (the other side in the axial direction) from the upper toward the lower.

<Release Arm> As shown in FIG. 7, the release arms 50A to 50D are provided on the left side (the other side in the axial direction) of the support member 41. As shown in FIG. 7 and FIG. 8, the release arm 50 has an annular portion 51 (51A to 51D) and an arm portion 52 (52A to 52D).

The annular portion 51 is formed in an annular shape, and the drive coupling 38 is inserted into the annular portion 51. Thus, the release arm 50 is turnably provided along the outer peripheral surface of the drive coupling 38. The arm portion 52 extends radially outward from the outer peripheral surface of the annular portion 51. The arm portion 52 is formed to be contactable with the inclined surface portion 46 formed on the attachment guide 43 (support member 41). The release arm 50 is moved in the left-and-right direction (axial direction) by turning while bringing the arm portion 52 into contact with the inclined surface portion 46.

As shown in the upper part of FIG. 9, when the release arm 50 is moved leftward while turning in the counterclockwise direction, as shown in the lower part of FIG. 9, the tip (left end) of the annular portion 51 abuts against the drive rib 39 to move the drive coupling 38 leftward against the biasing force of the biasing coupling member 40. Thus, the drive coupling 38 is separated from the drive transmission gear 37, and the transmission of the drive force to the developing roller 31 is interrupted.

<First Slider> As shown in FIG. 4 and FIG. 7, the first slider 54 is provided on the left side (the other side in the axial direction) of the support member 41. More specifically, the first slider 54 is disposed between the support body part 42 and the attachment guide 43 (see also FIG. 10). The first slider 54 contains a monochrome slider 55 corresponding to the monochrome image developing device 22D and a color slider 56 corresponding to the color image developing devices 22A to 22C. The monochrome slider 55 and the color slider 56 are each formed into a long and thin rod elongated in the front-and-rear direction. In the present specification, for convenience of explanation, the rear side (one side of the separation direction) is referred to as the “engagement direction D1” and the front side (the other side of the separation direction) is referred to as the “disengagement direction D2”. Therefore, the first slider 54 is movable in the engagement direction D1 and the disengagement direction D2.

(Monochrome Slider) The monochrome slider 55 is supported by the attachment guide 43 movably in the front-and-rear direction (separation direction). As shown in FIG. 7, the monochrome slider 55 has a slider housing portion 55a capable of housing the color slider 56 which is formed in the portion excluding the front side portion. The slider housing portion 55a is formed in such a manner that the left side portion of the monochrome slider 55 is largely cut off, and a butting step portion 55b is formed at the front end portion of the slider housing portion 55a. A first joint shaft portion 57 (see FIG. 4) is formed at the rear end portion of the monochrome slider 55 via a bracket 55c projecting rightward. The first joint shaft portion 57 projects downward from the lower surface of the bracket 55c.

As shown in FIG. 4, FIG. 5 and FIG. 7, the monochrome slider 55 has a first projection 61D provided so as to be contactable with the monochrome image release arm 50D, and a second projection 62D provided so as to be contactable with (the left end of) the monochrome image developing device 22D. The first projection 61D projects leftward from the lower portion of the left side surface of the monochrome slider 55 on the front side of the slider housing portion 55a. The second projection 62D projects rightward from the lower portion of the right side surface of the monochrome slider 55 on the front side of the monochrome slider 55. The second projection 62D is provided at a position shifted forward (disengagement direction D2) from the first projection 61D.

(Color slider) As shown in FIG. 4, FIG. 5 and FIG. 7, the color slider 56 is supported by the slider housing portion 55a of the monochrome slider 55 movably in the front-and-rear direction. A biasing housing portion 56a (see FIG. 7) capable of housing a biasing member 60 is formed in the rear side portion of the color slider 56. The biasing member 60 is, for example, a compression coil spring, and is provided between the front end of the biasing housing portion 56a and the rear portion of the attachment guide 43, and biases the color slider 56 forward (disengagement direction D2).

The color slider 56 has first projections 61A to 61C provided so as to be contactable with the color image release arms 50A to 50C, and second projections 62A to 62C provided so as to be contactable with (left ends of) the color image developing devices 22A to 22C. The three first projections 61A to 61C are arranged at substantially equal intervals in the front-and-rear direction, and project leftward from the lower portion of the left side surface of the color slider 56. The three second projections 62A to 62C are arranged at substantially equal intervals in the front-and-rear direction, and project rightward from the lower portion of the right side surface of the color slider 56. The second projection 62A is provided at a position shifted forward (disengagement direction D2) from the first projection 61A. Similarly, the second projections 62B and 62C are provided at positions shifted forward from the first projections 61B and 61C, respectively.

<Second Slider> As shown in FIG. 4, FIG. 7, and FIG. 10, the second slider 58 is formed into a long rod shape elongated in the front-and-rear direction, and is provided on the right side (one side in the axial direction) of the support member 41. The second slider 58 is supported by the support body part 42 movably in the front-and-rear direction (separation direction). Although the details will be described later, the second slider 58 is provided to be movable in the engagement direction D1 and the disengagement direction D2 in conjunction with the first slider 54.

As shown in FIG. 4 and FIG. 6, the second slider 58 has third projections 63A to 63D provided so as to be contactable with the right end portions (one end portion in the axial direction) of the developing devices 22A to 22D. The four third projections 63A to 63D are arranged at substantially equal intervals in the front-and-rear direction, and project leftward from the lower portion of the left side surface of the second slider 58. The four third projections 63A to 63D are arranged to face the four second projections 62A to 62D of the first slider 54 across the four developing devices 22A to 22D. Further, an engagement groove 58a is formed in the rear portion on the upper surface of the second slider 58, which is inclined rearward from the left toward the right as viewed from plan (see FIG. 10).

<First link> As shown in FIG. 4, FIG. 7, and FIG. 10, the first link 64 is formed in a flat plate shape bent in a substantially L-shape, and is turnably supported by the support member 41. Specifically, the first link 64 is supported by a first support shaft portion 47 provided at the center portion in the left-and-right direction of the rear portion on the upper surface of the support body part 42. The first link 64 is engaged with the first slider 54. More specifically, an elongated hole 70 (see FIG. 7) is formed at the left end portion of the first link 64, and the first joint shaft portion 57 of the monochrome slider 55 is inserted into the elongated hole 70 (see FIG. 4). The first joint shaft portion 57 is supported movably along the elongated hole 70 and rotatably in the elongated hole 70. An engagement recess 71 is formed at the right end portion of the first link 64.

<Second link> The second link 65 is formed in a flat plate shape bent substantially in an L-shape, and is turnably supported by the support member 41. More specifically, the second link 65 is bent in a direction opposite to that of the first link 64 as viewed from plan, and is supported by a second support shaft portion 48 provided at the rear and right end portion on the upper surface of the support body part 42. The right end portion of the second link 65 is engaged with the engagement groove 58a of the second slider 58. The left end portion of the second link 65 is engaged with the engagement recess 71 of the first link 64. The first link 64 and the second link 65 constitute a link mechanism for interlocking the first slider 54 and the second slider 58. The second link 65 is provided with a cylindrical lever support shaft portion 72 on the same axis as the second support shaft portion 48.

<Manual Lever> The manual lever 66 is formed in a rod shape bent in a substantially L-shape, and is coupled to the upper end portion of the lever support shaft portion 72 serving as a rotational shaft of the second link 65. The manual lever 66 is turned by an operator. When the operator grips the manual lever 66 and turns it around the shaft, the first link 64 and the second link 65 are turned in opposite directions to each other to move the first slider 54 and the second slider 58 in the same direction.

<Slide Driving Part> The slide driving part 67 is connected to the color slider 56 (see FIG. 4). The slide driving part 67 includes an actuator, such as an eccentric cam rotated by a solenoid or a servo motor, and is configured to push (or pull) the color slider 56 in the engagement direction D1. The slide driving part 67 moves only the color slider 56 in the engagement direction D1 in a state where the monochrome slider 55 is moved in the disengagement direction D2. When the slide driving part 67 releases the pressing force (or tension) against the color slider 56, the monochrome slider 55 moved in the engagement direction D1 is biased by the biasing member 60 to be moved in the disengagement direction D2.

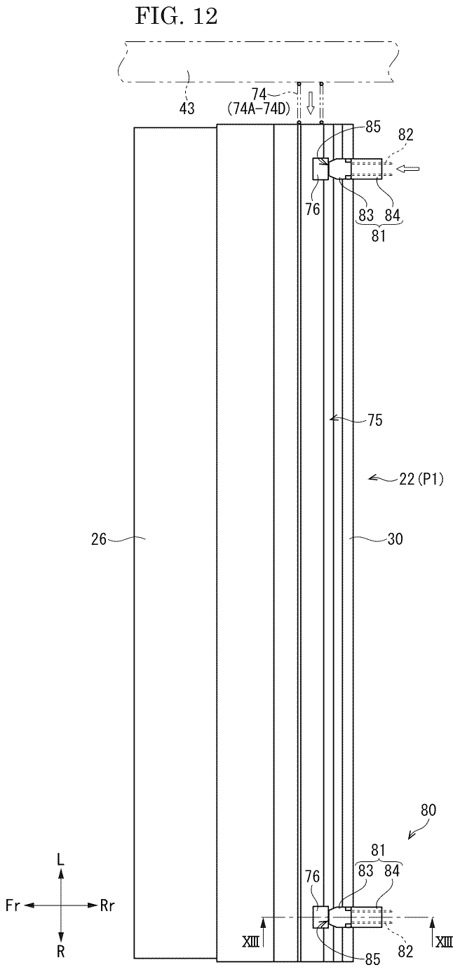

On the right side surface of the attachment guide 43, a pull-out auxiliary member 74 (74A to 74D) is supported at a position corresponding to the developing device 22 (see FIG. 12 to be described later). The pull-out auxiliary member 74 is, for example, a compression coil spring, and is provided between the left side surface of the developing device 22 (developing container 30) supported by the rail portion 44 of the support body part 42 and the right side surface of the attachment guide 43. The pull-out auxiliary member 74 biases the developing device 22 disposed at the separation position P2 rightward (one of the axial directions, which is the direction in which the developing device is pulled out from the apparatus main body 2). Thus, the developing device 22 disposed at the separation position P2 can be pushed outward (rightward) from the apparatus main body 2, and the operator can easily take out the developing device 22.

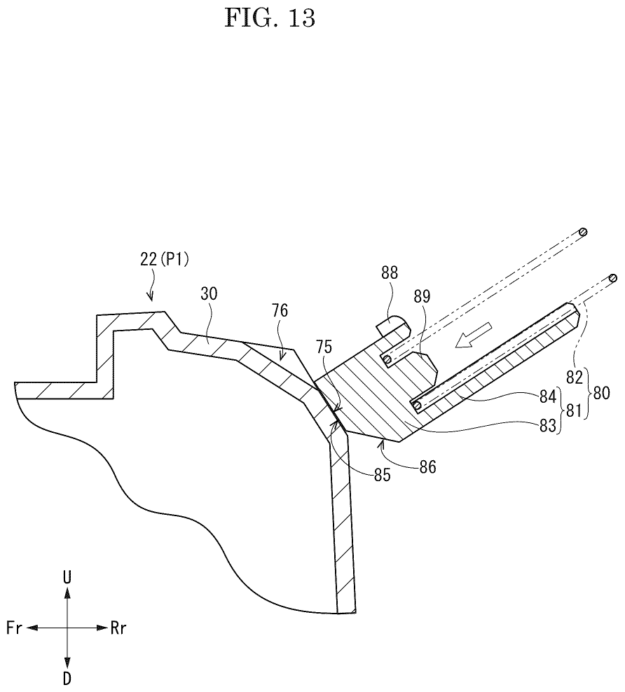

Incidentally, it is necessary to return the developing device 22 to the developing position P1 after the developing device 22 is disposed at the separation position P2 and the developing device 22 and then the others are maintained or replaced. In addition, in the state where the developing device 22 is disposed at the developing position P1, each of the regulating rollers 73 of the developing roller 31 must be kept in contact with the photoconductive drum 20 in order to maintain a predetermined distance between the developing roller 31 and the photoconductive drum 20. Therefore, the image forming apparatus 1 according to the present embodiment includes pressing devices 80A to 80D which press the developing devices 22 from the separation position P2 toward the developing position P1.

[Pressing Device] With reference to FIG. 6, and FIG. 11 to FIG. 13, the pressing devices 80A to 80D will be described. FIG. 11 is a perspective view showing a part of the developing device 22 and the pressing device 80. FIG. 12 is a plan view showing the developing device 22 (developing position P1) and the pressing device 80. FIG. 13 is a cross-sectional view taken along the line XIII-XIII of FIG. 12.

As shown in FIG. 6, the four pressing devices 80A to 80D are provided corresponding to the four developing devices 22A to 22D. As shown in FIG. 11 and FIG. 12, each pressing device 80 includes a pair of contact members 81 (81A to 81D) and a pair of pressing members 82 (82A to 82D). Since the four pressing devices 80A to 80D have the same structure, one pressing device 80 (only arithmetic numerals are added to the reference numerals) will be mainly described in the specification. In each pressing device 80, since the pair of contact members 81 have the same structure, one contact member 81 will be mainly described in this specification. For the same reason, one pressing member 82 will be mainly described.

<Contact Member> As shown in FIG. 12, the pair of contact members 81 are disposed apart from each other in the left-and-right direction (axial direction), and are in contact with the vicinity of the upper rear surface of the developing device 22 (developing container 30). The contact member 81 extends in the front-and-rear direction as a whole, and is set in a posture inclined downward (toward the developing container 30) from the rear toward the front (see FIG. 11). The contact member 81 is slidably supported on the top surface of the support body part 42. The contact member 81 slides in a direction along its own inclination while maintaining the inclined posture.

As shown in FIG. 11 to FIG. 13, the contact member 81 has a contact body portion 83 and a pressing support portion 84. The contact body portion 83 and the pressing support portion 84 are integrally molded of, for example, synthetic resin material.

(Contact Body Portion) The contact body portion 83 is formed in a substantially rectangular parallelepiped shape. The distal portion (front lower portion) of the contact body portion 83 is a portion which comes into contact with (abuts against) the vicinity of the upper rear surface of the developing container 30. At the distal portion of the contact body portion 83, a pressing surface 85 is formed to be in contact with a pressure-receiving surface 75 formed on the upper rear surface of the developing container 30. The pressing surface 85 is a surface inclined upward from the rear toward the front. In the state where the developing device 22 is disposed at the developing position P1, the pressure-receiving surface 75 is substantially parallel to the pressing surface 85, and the pressing surface 85 and the pressure-receiving surface 75 are brought into contact (surface contact) with each other substantially on their entire surfaces (see FIG. 13). A lower inclined surface 86 is formed at the lower corner of the distal portion of the contact body portion 83 so as to continue to the lower end of the pressing surface 85 (see FIG. 13). Further, a pair of side inclined surfaces 87 are formed at both right and left corners of the distal portion of the contact body portion 83 (see FIG. 11).

A pair of left and right pressing-restricting projections 88 project from the upper surface of the contact body portion 83 (see FIG. 11). Each of the pressing-restricting projections 88 is engaged with the support body part 42 to restrict the sliding of the contact member 81 obliquely forward and downward (in the direction close to the developing container 30). Further, a support boss 89 for supporting the front end portion of the pressing member 82 is provided on the proximal end portion (rear portion) of the contact body portion 83 (see FIG. 13).

(Fitting Recess) As shown in FIG. 11, a pair of right and left fitting recesses 76 (76A to 76D) in which the contact member 81 (the distal portion of the contact body portion 83) is detachably fitted are formed on the upper surface of the developing container 30 (developing device 22). As shown in FIG. 11 to FIG. 13, the fitting recess 76 is a shallow groove formed on the upper surface of the developing container 30 so as to continue to the upper end of the pressure-receiving surface 75. No step is formed between the fitting recess 76 and the pressure-receiving surface 75, and no step is formed between the front end of the fitting recess 76 and the upper surface of the developing container 30. Substantially triangular inner surfaces stand up at both right and left ends of the fitting recess 76, and a step is formed between both right and left ends of the fitting recess 76 and the upper surface of the developing container 30. In the present specification, the state where the contact member 81 (the distal portion of the contact body portion 83) is fitted into the fitting recess 76 does not mean that the distal portion of the contact body portion 83 is immovably fitted into the fitting recess 76, but that the distal portion of the contact body portion 83 is movably fitted into the fitting recess 76.

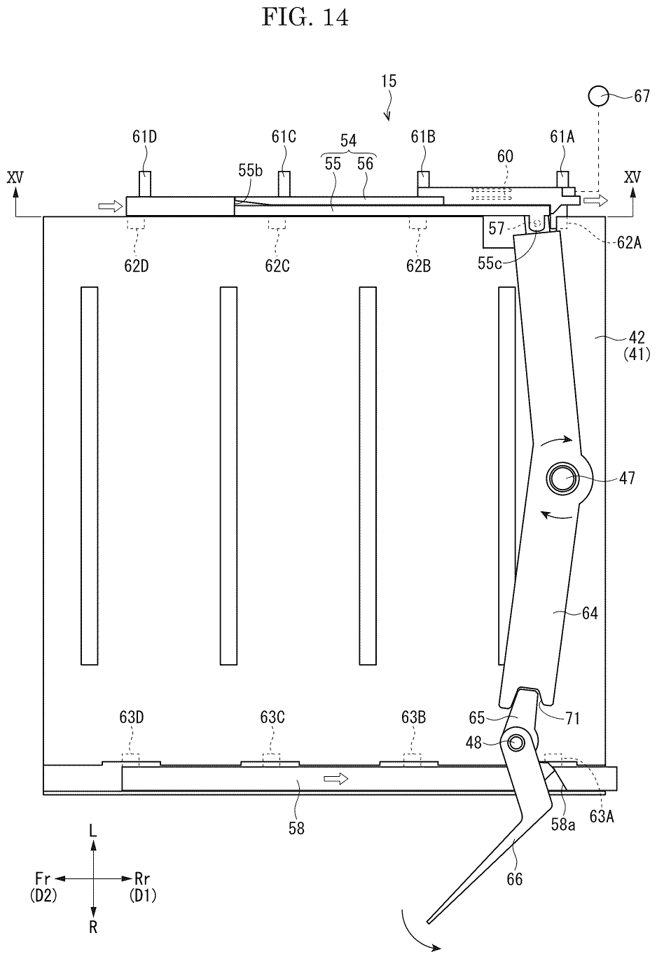

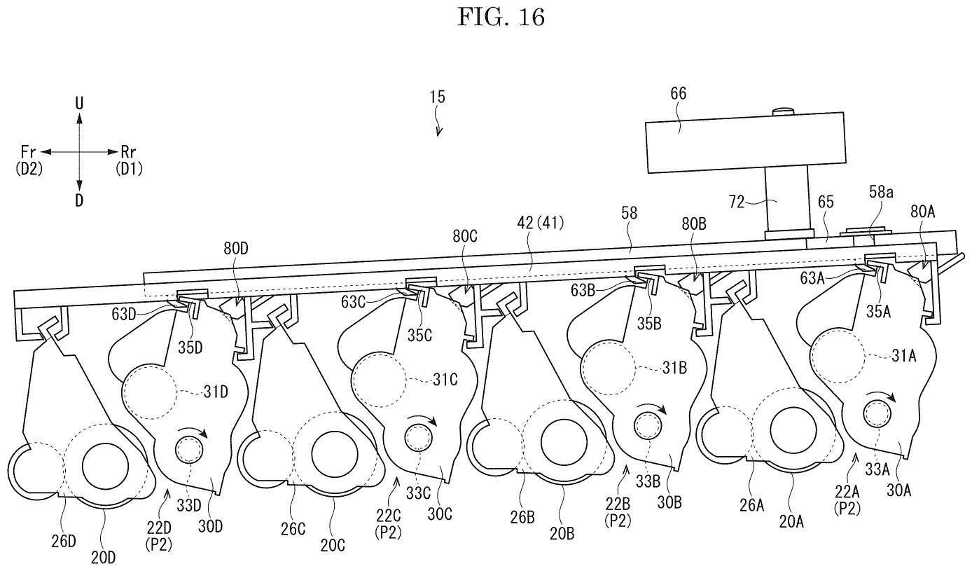

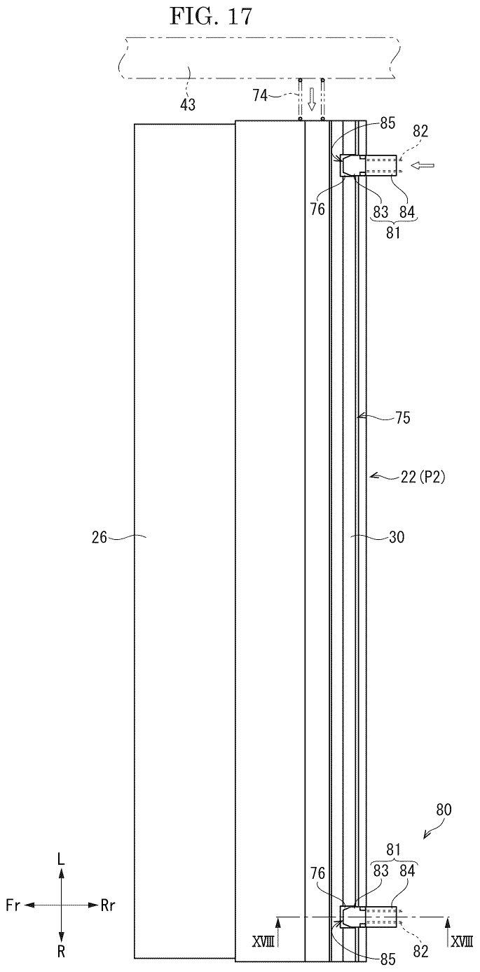

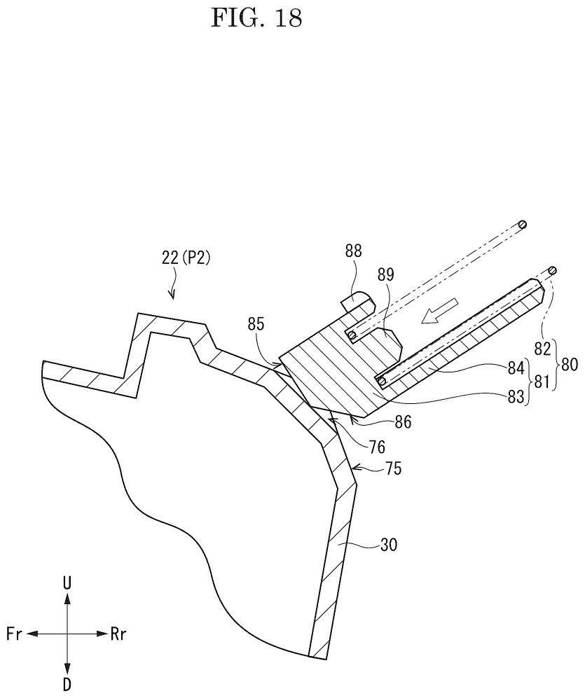

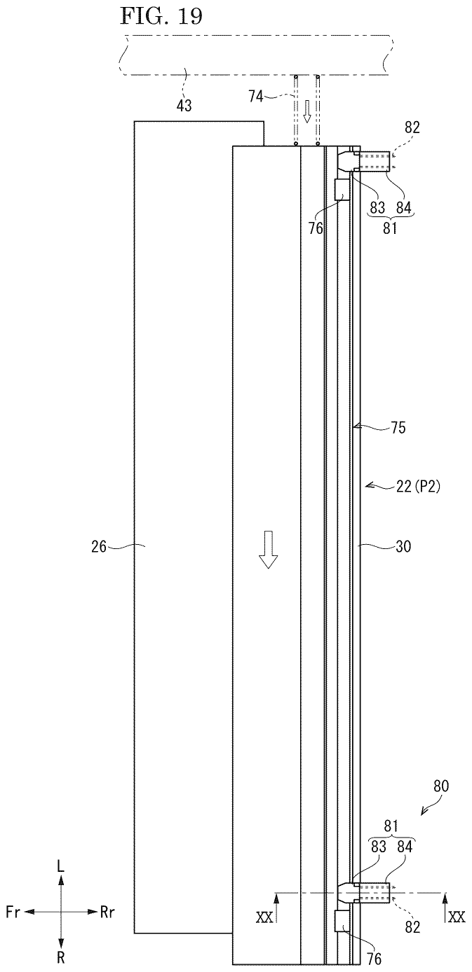

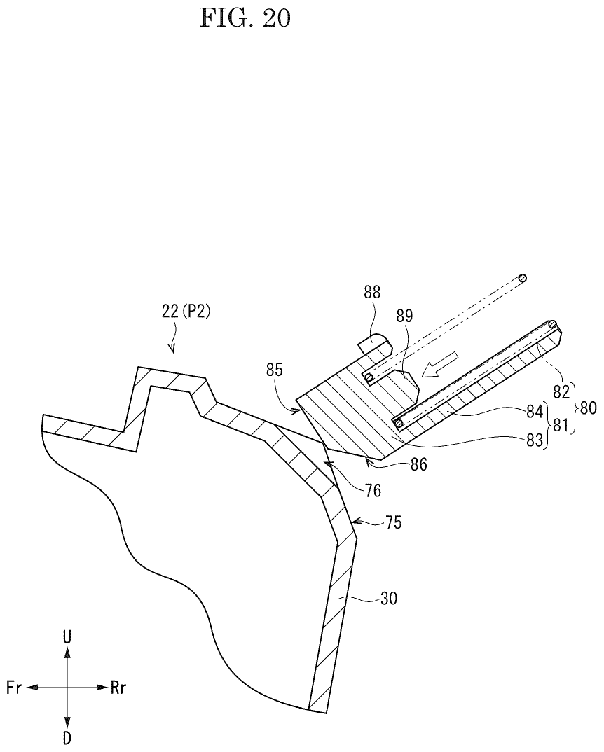

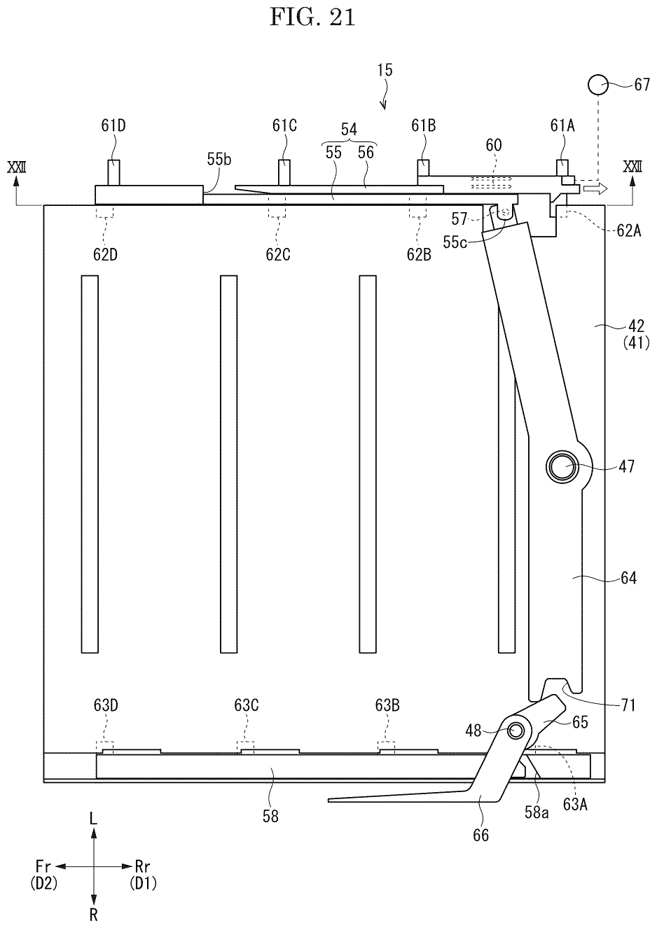

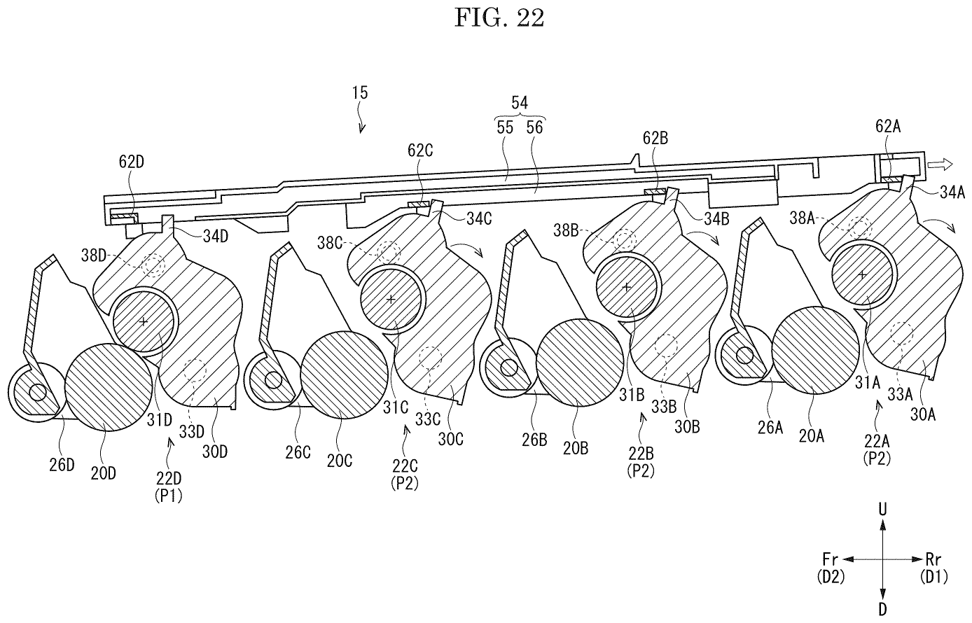

(Pressing Support Portion) The pressing support portion 84 is formed in a substantially flat plate shape and extends rearward (obliquely rearward and upward) from the lower portion of the proximal end portion (rear portion) of the contact body portion 83 (see FIG. 11).

<Pressing Member> The pressing member 82 is, for example, a compression coil spring and is disposed on the pressing support portion 84. The pressing member 82 is provided between the top surface portion of the support body part 42 and the contact body portion 83. The support boss 89 of the contact body portion 83 is fitted to the front end portion of the pressing member 82 (see FIG. 13). The pressing member 82 presses the contact member 81 against the developing device 22 (developing container 30).

[Operation of Separation Device and Pressing Device] Next, with reference to FIG. 4 to FIG. 6, FIG. 8, FIG. 9, and FIG. 12 to FIG. 22, the operation (action) of the separation device 15, that is, the separation/contact operation of the developing device 22 with respect to the photoconductive drum 20 will be described. Together with this description, the operation (function) of the pressing device 80 will be described. FIG. 14 is a plan view showing the separation device 15 (an insertable/removable state). FIG. 15 is a cross-sectional view taken along the line XV-XV of FIG. 14. FIG. 16 is a right side view showing the photoconductive drum 20, the developing device 22 (the separation position P2), and the separation device 15. FIG. 17 is a plan view showing the developing device 22 (separation position P2), and the pressing device 80. FIG. 18 is a cross-sectional view taken along the line XVIII-XVIII of FIG. 17. FIG. 19 is a plan view showing a process of pulling out the developing device 22. FIG. 20 is a cross-sectional view taken along the line XX-XX of FIG. 19. FIG. 21 is a plan view showing the separation device 15 (a monochrome printing state). FIG. 22 is a cross-sectional view taken along the line XXII-XXII of FIG. 21.

Here, as shown in FIG. 4 to FIG. 6, the initial state is set to a state in which the first to second sliders 54 and 58 are moved in the disengagement direction D2 in a posture where the gripping portion of the manual lever 66 is aligned in the front-and-rear direction, all the developing devices 22 are disposed at the developing position P1, and all the drive couplings 38 are coupled to all the drive transmission gears 37. In this specification, the initial state is the same as the normal printing state described later.

<Initial State> First, in the initial state (when the developing device 22 is disposed at the developing position P1), the contact member 81 of the pressing device 80 is pressed on a position separated from the fitting recess 76 in the turning direction of the developing device 22. Specifically, as shown in FIG. 12 and FIG. 13, the contact body portion 83 of the contact member 81 brings the pressing surface 85 in surface-contact with the pressure-receiving surface 75 of the developing container 30. The pressing member 82 presses the contact body portion 83 (pressing surface 85) against the pressure-receiving surface 75, thereby biasing the developing device 22 toward the photoconductive drum 20. Each regulating roller 73 (see FIG. 11) of the developing roller 31 is pressed against the surface of the photoconductive drum 20, and the gap between the developing roller 31 and the photoconductive drum 20 is kept at a substantially constant value. As described above, since the pressing device 80 presses the developing device 22 from the separation position P2 toward the developing position P1, the developing device 22 can be positioned at the developing position P1. This allows the developing roller 31 to be maintained in a state close to the photoconductive drum 20, so that the proper development process can be performed.

<Case where Developing device and the others are Pulled Out> For example, when the photoconductive drum 20 or the developing device 22 is pulled out (removed) from the apparatus main body 2 for maintenance or replacement, the operator opens the cover 2A provided on the right side surface of the apparatus main body 2 to expose the right end surfaces of the photoconductive drum 20 and the developing device 22 (see FIG. 3). More specifically, when the cover 2A is opened, the retainer (not shown) covering the right end surfaces of photoconductive drum 20 and developing device 22 is exposed, and then when the retainer is opened, the right end surfaces of photoconductive drum 20 and the developing device 22 are exposed. The retainer is, for example, turnably connected to the apparatus main body 2 around the lower end.

As shown in FIG. 14, the operator grasps the manual lever 66 and pulls it forward (rightward) to turn the manual lever 66 in the counterclockwise direction (in one direction) as viewed from plan. Then, the second link 65 is turned in the counterclockwise direction around the second support shaft portion 48, and the first link 64 is turned in the clockwise direction around the first support shaft portion 47. That is, as the manual lever 66 is turned, the second link 65 is turned in the same direction as the manual lever 66, while the first link 64 is turned in the opposite direction to the manual lever 66 in conjunction with the second link 65.

When the manual lever 66 is turned in the counterclockwise direction (one direction), the first link 64 moves the monochrome slider 55 in the engagement direction D1 (from the front to the rear) (see FIG. 15), and the second link 65 moves the second slider 58 in the engagement direction D1 (see FIG. 16). Since the color slider 56 brings the front end surface into contact with the abutting step portion 55b of the slider housing portion 55a, the color slider 56 moves integrally with the monochrome slider 55 in the engagement direction D1 (rearward).

When the first slider 54 (monochrome slider 55 and color slider 56) is moved in the engagement direction D1, the four first projections 61A to 61D are in contact with the arm portions 52A to 52D of the corresponding release arms 50A to 50D to push the release arms 50A to 50D in the engagement direction D1 (rearward) (see the upper part of FIG. 9). The release arms 50A to 50D are turned in the engagement direction D1 (in the counterclockwise direction in the upper part of FIG. 9) while bringing the arm portions 52A to 52D into contact with the inclined surfaces 46A to 46D, and moves in parallel leftward (to the separation position P4). The release arms 50A to 50D bring the left end portions into contact with the drive ribs 39A to 39D of the drive couplings 38A to 38D, and push the drive couplings 38A to 38D leftward to separate them from the developing rollers 31A to 31D (drive transmission gears 37A to 37D) (see the lower part of FIG. 9). In this state, the couplings between all the developing rollers 31 and all the drive input gears 36 are released, and the drive transmissions to all the developing rollers 31 are interrupted.

After all the drive couplings 38A to 38D are separated from all the drive transmission gears 37A to 37D (developing rollers 31A to 31D), as shown in FIG. 15, the four second projections 62A to 62D are in contact with the first engagement portions 34A to 34D of the corresponding developing devices 22A to 22D, and push the developing devices 22A to 22D in the engagement direction D1. Furthermore, as shown in FIG. 16, the four third projections 63A to 63D are into contact with the second engagement portions 35A to 35D of the corresponding developing devices 22A to 22D, and push the developing devices 22A to 22D in the engagement direction D1. As described above, when the first and second sliders 54 and 58 are moved in the engagement direction D1, the second projections 62A to 62D and the third projections 63A to 63D push the developing devices 22A to 22D in the engagement direction D1 to turn them from the developing position P1 to the separation position P2 (see FIG. 15 and FIG. 16).

The developing device 22 is turned from the developing position P1 to the separation position P2 against the pressing force of the pressing device 80 (pressing member 82). As shown in FIG. 17 and FIG. 18, as the developing device 22 is turned, the contact member 81 (contact body portion 83) moves relatively from the position in contact with the pressure-receiving surface 75 to the position in contact with the bottom surface of the fitting recess 76. Specifically, as the developing device 22 is turned toward the separation position P2, the pressing surface 85 of the contact body portion 83 moves relatively toward the fitting recess 76 while in contact with the pressure-receiving surface 75. As the developing device 22 is turned further, the pressing surface 85 gradually separates from the pressure-receiving surface 75, and the boundary portion between the pressing surface 85 and the lower inclined surface 86 moves relatively while in contact with the bottom surface (inner surface) of the fitting recess 76. When the developing device 22 is disposed at the separation position P2, the contact member 81 (the distal portion of the contact body portion 83) is fitted into the fitting recess 76 and pressed against the bottom surface (inner surface) of the fitting recess 76.

As described above, the image forming apparatus 1 is set in an insertable/removable state where all the developing devices 22 are disposed at the separation position P2 (see FIG. 9, FIG. 14 to FIG. 16). In the insertable/removable state, the manual lever 66 is turned in the counterclockwise direction (in one direction), the monochrome slider 55 and the color slider 56 is moved in the engagement direction D1, all the first projections 61 press all the release arms 50, and all the second projections 62 and all the third projections 63 press all the developing devices 22. Furthermore, the force in which the second projection 62 and the third projection 63 press the developing device 22 is substantially balanced by the force in which the pressing member 82 presses the developing device 22 via the contact member 81, and the developing device 22 is held at the separation position P2. Furthermore, in the state where the contact member 81 is biased by the pressing member 82 and fitted in the fitting recess 76, the developing device 22 is prevented from moving rightward (the pull-out direction) by the biasing force of the pull-out auxiliary member 74.

After the developing device 22 is disposed at the separation position P2 (after being set in the insertable/removable state), the operator pulls out the photoconductive drum 20 and the developing device 22 rightward. The third projection 63 of the second slider 58 engages with the second engagement portion 35 of the developing device 22 to guide the developing device 22 to be pulled out from the apparatus main body 2.

When the developing device 22 begins to be pulled out, the left upper edge of the fitting recess 76 is pressed against the left side inclined surface 87 of the contact member 81, and pushes the contact member 81 upward against the biasing force (pressing force) of the pressing member 82. As the developing device 22 is further pulled out, as shown in FIG. 19 and FIG. 20, the distal portion of the contact body portion 83 rides over the step of the fitting recess 76 and comes into contact with the upper surface of the developing container 30. That is, when the developing device 22 disposed at the separation position P2 moves rightward (axial direction), the contact member 81 is pressed against the position separated leftward (axial direction) from the fitting recess 76. When the contact member 81 (the distal portion of the contact body portion 83) is separated from the fitting recess 76, the developing device 22 is pushed out rightward under the biasing force of the pull-out auxiliary member 74 (see FIG. 19). The developing device 22 moves rightward (axial direction) while applied with the pressing force from the pressing device 80 (contact member 81). That is, the contact member 81 moves relatively leftward while in contact with the upper surface of the developing container 30. As the developing device 22 is further pulled out, the right contact member 81 is fitted into the left fitting recess 76 of the developing container 30, but the developing device 22 is further pulled out, and the right contact member 81 is separated from the left fitting recess 76. In order to separate the contact member 81 fitted into the fitting recess 76 from the fitting recess 76, a relatively large force is required, however, in order to pull out the developing device 22 in the state where the contact member 81 is kept in contact with the upper surface of the developing container 30, such a large force is not required.

<Case where Developing device and the others are attached> The operator attaches (pushes in) the developing device 22 and the others to the apparatus main body 2 by following the reverse procedure of the procedure described above for pulling out the developing device 22 and the others from the apparatus main body 2. During this process, the third projection 63 of the second slider 58 engages with the second engagement portion 35 of the developing device 22, and guides the developing device 22 which is to be pushed in the apparatus main body 2. Furthermore, the developing device 22 moves leftward (axial direction) while applied with the pressing force from the pressing device 80 (contact member 81). That is, the contact member 81 moves relatively rightward while in contact with the upper surface of the developing container 30. As the developing device 22 is further pushed in, the developing device 22 (developing container 30) is in contact with the pull-out auxiliary member 74 and is pushed in while compressing the pull-out auxiliary member 74 (against the biasing force). As the developing device 22 is further pushed in, the pair of contact members 81 are fitted into the pair of fitting recesses 76, and the first engagement portion 34 of the developing device 22 engages with the second projection 62 of the first slider 54. Thus, the developing device 22 is set in a state attached in the proper attachment position.

The operator grasps the manual lever 66 and pushes it leftward, and turns the manual lever 66 in the clockwise direction (the other direction) as viewed from plan (see FIG. 4). Then, the second link 65 is turned in the clockwise direction around the second support shaft portion 48, and the first link 64 is turned in the counterclockwise direction around the first support shaft portion 47. When the manual lever 66 is turned in the clockwise direction (the other direction), the first link 64 moves the monochrome slider 55 in the disengagement direction D2 (from the rear to the front), and the second link 65 moves the second slider 58 in the disengagement direction D2. The color slider 56 is biased by the biasing member 60, and moves together with the monochrome slider 55 in the disengagement direction D2 (forward).

When the first slider 54 (monochrome slider 55 and color slider 56) and the second slider 58 are moved in the disengagement direction D2, the four second projections 62A to 62D and the four third projections 63A to 63D are separated from the corresponding developing devices 22A to 22D in the disengagement direction D2 (forward) (see FIG. 5 and FIG. 6). All the developing devices 22A to 22D are applied with the biasing force (pressing force) of the pressing member 82 via the contact member 81 and turned from the separation position P2 to the developing position P1 (see FIG. 5 and FIG. 6).

After the second projections 62 and the third projections 63 are separated from the developing devices 22 in the disengagement direction D2, all the first projections 61A to 61D are separated from the corresponding release arms 50A to 50D in the disengagement direction D2 (in the upper part of FIG. 8, the pressing against the release arms 50 is released). As the release arms 50A to 50D are turned in the disengagement direction D2 (in the clockwise direction in the upper part of FIG. 8) while in contact with the inclined surfaces 46A to 46D, the drive couplings 38A to 38D are biased rightward (coupling position P3) by the biasing link members 40A to 40D and coupled to the drive transmission gears 37A to 37D (see the lower part of FIG. 8). Thus, the drive couplings 38A to 38D are coupled to the developing rollers 31A to 31D via the drive transmission gears 37A to 37D.

As described above, the image forming apparatus 1 is set in the normal printing state where all the developing devices 22 are disposed at the developing position P1 (see FIG. 4 to FIG. 6, FIG. 8). In the normal printing state, the manual lever 66 is turned in the clockwise direction (the other direction), the monochrome slider 55 and the color slider 56 are moved in the disengagement direction D2, all the second projections 62 and all the third projections 63 are separated from all the developing devices 22, and all the first projections 61 are separated from all the release arms 50. The pressing device 80 presses the developing device 22 from the separation position P2 toward the developing position P1. After the developing devices 22 are set in the normal printing state, the operator closes the cover 2A, enabling the execution of the image forming process.

According to the image forming apparatus 1 of the present embodiment described above, since the developing device 22 moves in the left-and-right direction (axial direction) while applied with the pressing force from the pressing device 80, it is possible to provide a certain resistance to the operator performing the attachment/detachment operation of the developing device 22. The operator performing the attachment/detachment operation can be given a sense of moving the developing device 22. This suppresses the pulling out and pushing in the developing device 22 with excessive force, and enables a stable attachment/detachment operation of the developing device 22.

Furthermore, the image forming apparatus 1 according to this embodiment is configured such that, when the developing device 22 is disposed at the separation position P2, the contact member 81 is fitted into the fitting recess 76 and pressed against the bottom surface (inner surface) of the fitting recess 76 (see FIG. 18). According to this configuration, the contact member 81 fitted into the fitting recess 76 can restrict the movement of the developing device 22 in the left-and-right direction (axial direction). This restricts the unintentional pulling out of the developing device 22 disposed at the separation position P2. Furthermore, when the developing device 22 is pushed in to attach the developing device 22 to the apparatus main body 2, the contact member 81 is fitted into the fitting recess 76, and a clicking sound and slight vibration are generated. Then, the operator feels the clicking sound and slight vibration, and can recognize that the developing device 22 is properly attached.

Furthermore, the image forming apparatus 1 according to this embodiment is configured such that the pull-out auxiliary member 74 biases the developing device 22 disposed at the separation position P2, in a direction for pulling out from the apparatus main body 2 (see FIG. 19). According to this configuration, when the operator pulls the developing device 22 disposed at the separation position P2 to release the contact member 81 from the fitting recess 76, the operator can pull out the developing device 22 semi-automatically due to the biasing force of the pull-out auxiliary member 74. Furthermore, since the contact member 81 fitted into the fitting recess 76 restricts the axial movement of the developing device 22, the movement of the developing device 22 disposed at the separation position P2 in the pull-out direction due to the biasing force of the pull-out auxiliary member 74 is suppressed. Furthermore, by pushing the developing device 22 to fit the contact member 81 into the fitting recess 76, the developing device 22 can be kept at the separation position P2.

<Case where Monochrome Image is printed> For example, when the image data transmitted from an external terminal (such as a personal computer) is a monochrome image (an image formed using only black toner), the control part (not shown) of the image forming apparatus 1 drives and controls the slide driving part 67. The cover 2A of the apparatus main body 2 is closed, and the manual lever 66 is kept in the clockwise (the other direction) turned (the manual lever 66 is not operated). Furthermore, the operation of the pressing device 80 is the same as described above in the case of <Case where Developing Device and the other are pulled out>, so its description is omitted.

The slide driving part 67 moves the color slider 56 in the engagement direction D1 (from the front to the rear). At this time, as shown in FIG. 21 and FIG. 22, the monochrome slider 55 does not move and is held in the state moved in the disengagement direction D2 (forward), and only the color slider 56 moves in the engagement direction D1 (rearward) against the biasing force of the biasing member 60. The second slider 58 is not also moved and held in a state moved in the disengagement direction D2 (forward).

The three first projections 61A to 61C of the color slider 56 push the corresponding release arms 50A to 50C in the engagement direction D1 (rearward) (see FIG. 9). The three release arms 50A to 50C are turned in the engagement direction D1 (in the counterclockwise direction in the upper part of FIG. 9) while in contact with the inclined surfaces 46A to 46D, and push the drive couplings 38A to 38C leftward. The drive couplings 38A to 38C are separated from the developing rollers 31A to 31C (drive transmission gears 37A to 37C), and the developing rollers 31A to 31C are decoupled from the drive input gears 36A to 36C and the drive transmission to the developing rollers 31A to 31C is interrupted (see the lower part of FIG. 9). The drive coupling 38D is coupled to the drive transmission gear 37D, and the drive transmission to developing roller 31D is maintained.

After the drive couplings 38A to 38C are decoupled from the drive transmission gears 37A to 37C, as shown in FIG. 22, the three second projections 62A to 62C of the color slider 56 are in contact with the first engagement portions 34A to 34C of the corresponding developing devices 22A to 22C, and pushes the developing devices 22A to 22D in the engagement direction D1. Then, the second projections 62A to 62C push the developing devices 22A to 22C in the engagement direction D1 to turn them from the developing position P1 to the separation position P2.

As described above, the image forming apparatus 1 is set to the monochrome printing state where the monochrome image developing device 22D is disposed at the developing position P1, and the color developing devices 22A to 22C are disposed at the separation position P2 (see FIG. 21 and FIG. 22). In the monochrome printing state, the manual lever 66 is turned in the other direction, the monochrome slider 55 is moved in the disengagement direction D2 (forward), the second projection 62D of the monochrome slider 55 is released from the monochrome image developing device 22D, and the first projection 61D of the monochrome slider 55 is separated from the release arm 50D. Furthermore, in the monochrome printing state, the slide driving part 67 moves the color slider 56 in the engagement direction D1 (rearward), the first projections 61A to 61C of the color slider 56 pushes the release arms 50A to 50C, and the second projections 62A to 62C of the color slider 56 push the color image developing devices 22A to 22C. In the monochrome printing state, all the third projections 63 are separated from all the developing devices 22.

The control part of the image forming apparatus 1 executes the monochrome image forming process after setting it in the monochrome printing state. When the control part stops driving the slide driving part 67 after the completion of the monochrome image formation process, the color slider 56 is biased by the biasing member 60 and moved in the disengagement direction D2, and the image forming apparatus 1 returns to the normal printing state through the reverse procedure of the above-described procedure.

In the image forming apparatus 1 of this embodiment, one pair of contact members 81 and one pair of pressing members 82 are provided for one developing device 22; however, the present disclosure is not limited thereto. One or more contact members 81 and the pressing members 82 may be provided (not shown).

Furthermore, the image forming apparatus 1 according to this embodiment includes the pull-out auxiliary member 74 which biases the developing device 22, disposed at the separation position P2, in the direction for pulling out from the apparatus main body 2. However, the present disclosure is not limited to this configuration, and the pull-out auxiliary member 74 may be omitted (not shown).

In the image forming apparatus 1 of this embodiment, the developing roller 31 is coupled to the drive input gear 36 (drive motor) via the drive coupling 38. However, the present disclosure is not limited to this configuration. For example, the drive coupling 38 may be omitted, and the developing roller 31 may be directly coupled to the drive input gear 36 (drive motor) (not shown). In this case, it is preferable to provide the drive input gear 36 movably in the axial direction.

In the image forming apparatus 1 of this embodiment, the operator manually operates the manual lever 66 to slide the first and second sliders 54, 58 to switch the state of the image forming apparatus 1 between the insertable/removable state and the normal printing state. However, the present disclosure is not limited to this. For example, a drive source (not shown) for sliding the first and second sliders 54, 58 may be provided, and based on terminal operation by the operator, the control part may drive and control the drive source to slide the first and second sliders 54, 58 in a linked manner. In this case, the first and second links 64, 65 and the manual lever 66 may be omitted (not shown).

Furthermore, in the image forming apparatus 1 according to this embodiment, the release arm 50 is turned (swung) to decouple or couple the developing roller 31 and the drive input gear 36. However, the present disclosure is not limited to this. For example, the release arm 50 may be omitted, a drive source (not shown) may be provided to reciprocate the drive coupling 38 (or the drive input gear 36) axially, and the control part may drive and control the drive source to decouple or couple the developing roller 31 and the drive input gear 36.

Furthermore, in the image forming apparatus 1 of this embodiment, the first slider 54 and the second slider 58 are provided on both sides of the developing device 22 in the axial direction, but the present disclosure is not limited thereto. For example, it may be configured such that the second slider 58 is omitted, and the developing device 22 is turned by the first slider 54 (not shown).

Furthermore, the image forming apparatus 1 according to this embodiment is a color printer capable of forming a color image, but the present disclosure is not limited thereto. For example, it may be a monochrome printer capable of forming only a monochrome image. That is, it may be provided with only the image forming part 11D, such as the photoconductive drum 20D and the developing device 22D (not shown). In this case, the first slider 54 may be configured solely with the monochrome slider 55 (not shown).

Furthermore, while the above embodiment description illustrated an example of applying the present disclosure to the color printer, it is not limited thereto. For example, the present disclosure may also be applied to a copying machine, a facsimile machine, or a multifunctional peripheral.

The description of the above embodiment illustrates one aspect of an image forming apparatus according to the present disclosure. The technical scope of the present disclosure is not limited to the above embodiment. The present disclosure may be variously modified, substituted, or transformed without departing from the spirit of the technical idea. The claims encompass all possible embodiments within the scope of the technical idea.

### Appendix 1

An image forming apparatus according to Appendix 1 includes:
an image carrier which is attached to an apparatus main body, and carries an electrostatic latent image while rotating around an axis;
a developing device which includes a developing member rotating around an axis, is attached to the apparatus main body movably in an axial direction, and brings the developing member close to or in contact with the image carrier to develop the electrostatic latent image;
a separation device which turns the developing device between a developing position where the developing device can perform the developing the electrostatic latent image and a separation position where the developing device can move in the axial direction; and
a pressing device which presses the developing device from the separation position to the developing position, wherein
the developing device is turned from the developing position to the separation position against a pressing force of the pressing device and moves in the axial direction while applied with the pressing force from the pressing device.

### Appendix 2

The image forming apparatus according to Appendix 2 is the image forming apparatus according to Appendix 1, wherein
the pressing device includes:
a contact member which is in contact with the developing device; and
a pressing member which presses the contact member on the developing device,
the developing device has a fitting recess into which the contact member is detachably fitted,
the contact member is pressed against a position separated away from the fitting recess in a turning direction of the developing device when the developing device is disposed at the developing position,
the contact member is fitted into the fitting recess and pressed against a bottom surface of the fitting recess when the developing device is disposed at the separation position, and
the contact member is pressed against a position separated away from the fitting recess in the axial direction when the developing device disposed at the separation position is moved in the axial direction.

### Appendix 3

The image forming apparatus according to Appendix 3 is the image forming apparatus according to Appendix 2, wherein,
the bottom surface of the fitting recess continues to a pressure receiving surface with which the developing device comes into contact when the developing device is disposed at the developing position.

### Appendix 4

The image forming apparatus according to Appendix 4 is the image forming apparatus according to Appendix 2 or 3, wherein
a step is formed between the bottom surface of the fitting recess and an upper surface of the developing device with which the contact member comes into contact when the developing device moves in the axial direction.

### Appendix 5

The image forming apparatus according to Appendix 5 is the image forming apparatus according to any one of Appendixes 2 to 4, wherein
when the developing device moves in the axial direction and the contact member is pressed by the pressing member and fitted into the fitting recess, a click sound or vibration is generated.

### Appendix 6

The image forming apparatus according to Appendix 6 is the image forming apparatus according to any one of Appendixes 1 to 5 and includes:
a pull-out auxiliary member which pulls out the developing device disposed at the separation position in one direction of the axial direction, which is a direction for pulling out the developing device from the apparatus main body.

What is claimed is:

1. An image forming apparatus comprising:
an image carrier which is attached to an apparatus main body, and carries an electrostatic latent image while rotating around an axis;
a developing device which includes a developing member rotating around an axis, is attached to the apparatus main body movably in an axial direction, and brings the developing member close to or in contact with the image carrier to develop the electrostatic latent image;
a separation device which turns the developing device between a developing position where the developing device can perform the developing the electrostatic latent image and a separation position where the developing device can move in the axial direction; and
a pressing device which presses the developing device from the separation position to the developing position, wherein
the developing device is turned from the developing position to the separation position against a pressing force of the pressing device and moves in the axial direction while applied with the pressing force from the pressing device.

2. The image forming apparatus according to claim 1, wherein
the pressing device includes:
a contact member which is in contact with the developing device; and
a pressing member which presses the contact member on the developing device,
the developing device has a fitting recess into which the contact member is detachably fitted,
the contact member is pressed against a position separated away from the fitting recess in a turning direction of the developing device when the developing device is disposed at the developing position,
the contact member is fitted into the fitting recess and pressed against a bottom surface of the fitting recess when the developing device is disposed at the separation position, and
the contact member is pressed against a position separated away from the fitting recess in the axial direction when the developing device disposed at the separation position is moved in the axial direction.

3. The image forming apparatus according to claim 2, wherein,
the bottom surface of the fitting recess continues to a pressure receiving surface with which the developing device comes into contact when the developing device is disposed at the developing position.

4. The image forming apparatus according to claim 2, wherein
a step is formed between the bottom surface of the fitting recess and an upper surface of the developing device with which the contact member comes into contact when the developing device moves in the axial direction.

5. The image forming apparatus according to claim 4, wherein
when the developing device moves in the axial direction and the contact member is pressed by the pressing member and fitted into the fitting recess, a click sound or vibration is generated.

6. The image forming apparatus according to claim 1, further comprising:
a pull-out auxiliary member which pulls out the developing device disposed at the separation position in one direction of the axial direction, which is a direction for pulling out the developing device from the apparatus main body.
